(19) United States
(12) Patent Application Publication
(10) Pub. No.: US 2005/0004840 A1
(43) Pub. Date: Jan. 6, 2005

(54) System and method for mobile telephone text message consumer promotions

(76) Inventor: Lester A. Wanninger, Edina, MN (US)

Correspondence Address: KINNEY & LANGE, P.A., THE KINNEY & LANGE BUILDING, 312 SOUTH THIRD STREET, MINNEAPOLIS, MN, 55415-1002, US

(21) Appl. No.: 10/850,090

(22) Filed: May 20, 2004

Related U.S. Application Data
(60) Provisional application No. 60/480,704, filed on Jun. 23, 2003.

(51) Int. Cl. G06F 17/60

(52) U.S. Cl. 705/14

(57) ABSTRACT

A system for providing an interactive promotion to a mobile device has a text messaging server, promotional content stored in a database and an operations and reporting system for retrieving promotional content from the database and generating text messages based on the promotional content for transmission via the text messaging server. The system provides direct marketing promotional content to a consumer who opts in via a wireless network. The consumer then interacts with the promotional system to receive incentives paid for by the client company.

### CROSS-REFERENCE TO RELATED APPLICATIONS(S)

This application claims the priority date of U.S. Provisional Application No. 60/480,704 filed on Jun. 23, 2003 and entitled “SYSTEM AND METHOD FOR MOBILE TELEPHONE TEXT MESSAGE CONSUMER PROMOTIONS”.

### BACKGROUND OF THE INVENTION

The present invention relates to mobile telephone based consumer promotions. More particularly, the present invention relates to mobile telephone based branding techniques for interactive consumer promotions sponsored by a corporation.

Millions of people currently use wireless telephone technologies, such as digital or cellular telephones. As the number of users has increased, the available technologies relating to wireless telephone systems have also increased and improved. Wireless application protocols, and various other web based services have been created to attempt to port Internet web page interfaces to wireless telephone technologies. However, at least at this time, the wireless telephones are ill equipped to handle such web services. More importantly, porting of typical web page technologies to the wireless telephone ignores the functional strengths and limitations of the wireless telephone.

One functional capacity that cellular and wireless telephones have developed and which has become increasingly popular, particularly among young people, is the instant text messaging function. Short Message Service (SMS) or other text based messaging protocols utilize communication channels that are embedded within or independent of traditional duplex voice communication channels, thereby allowing text-based messaging between mobile telephones without interfering with telephone calls.

Such text messages are relatively instantaneous, simple, and short. Within a matter of a few years, the volume of such text messaging has grown exponentially. For example, worldwide SMS text messaging volume was 12 billion per month in 2001, 20 billion in 2002 and is over 30 billion per month in 2003. The United States percentage of SMS text messaging volume remains a tiny percentage of that number.

During that same short period, people who utilize these short messages have developed their own lexicon (partially borrowed from Internet based chatrooms), including items which have been labeled “emoticons”. Generally, an emoticon is a sequence of ordinary ASCII characters arranged to show an emotional state in a plain text message. Typically, emoticons are punctuation-based facial expressions used to indicate particular emotions of the sender. Emoticons are used in e-mail, chat, SMS and other forms of communication using computers, wireless telephones, PDAs and the like. Hundreds of emoticons are already being used. The most popular emoticons are the smiling faces (such as “:-)”). The colon represents the eyes, the dash represents the nose, and the right parenthesis represent the mouth. When used properly, emoticons can contribute as much or more to the meaning of the message than the text itself.

In addition to the instant text messaging and creative emoticons, some people enjoy customizing their telephones. For instance, some people download sounds to provide unusual ringing tones such as musical tunes, download games or play games online using their wireless telephone or PDA. Ringing tones and picture images to display on the screen are typically downloaded in binary form to the mobile phone via text messages.

Most corporations today have an Internet presence. The Internet presence may be a static web site or a dynamic, server-driven interactive web site. Some corporations enjoy being on the leading edge of technology and are beginning to view the interaction of people via the instant text messaging as a potential vehicle for reaching consumers and for improving retail traffic. However, currently, there is no easy way to do so, and typical business models for telephone based interactions allocate costs in a way that is prohibitive for consumers, and particularly young people, to access the services.

Studies have shown that wireless telephone users who make use of the instant messaging service have positive feelings toward the messaging service in general. Thus, corporate branding efforts, if properly implemented, may take advantage of the generally positive consumer feelings in order to generate a positive branding experience for a corporate promotion.

### BRIEF SUMMARY OF THE INVENTION

Using simple messaging services available on wireless telephone systems, the system hosts and presents customized mobile marketing promotions targeted to mobile telephone users and particularly to teenage and young mobile telephone users. A system for providing an interactive promotion to a mobile device has a text messaging server, promotions software, promotional content stored in a database and an operations and reporting system for retrieving promotional content from the database and generating text messages based on the promotional content for transmission via the text messaging server. The system provides direct marketing promotional content to a consumer who opts in via a wireless network. The consumer then interacts with the promotional system to receive incentives paid for by the client company.

### BRIEF DESCRIPTION OF THE DRAWINGS

FIG. 1 is a schematic block diagram of the system of the present invention.

FIG. 2 is an expanded block diagram of the system of FIG. 1.

FIG. 3 is a flow diagram of the process of the present invention.

FIG. 4 is an expanded block diagram of the promotion system of FIG. 1.

FIG. 5 is an schematic block diagram of the promotion system of the present invention in conjunction with a chat television program.

### DETAILED DESCRIPTION

The present invention relates to mobile device technologies. Using the term “mobile” the present invention means portable. Typically, these mobile devices share a certain number of characteristics including portability, simplicity, familiarity of use, ubiquity, and versatility. Such mobile devices can be used everywhere by anybody at any time.

With the present invention, messages are communicated between consumers and client companies via mobile telephones or mobile devices. The messages come in many forms including text, binary, audio, video (SMS), Instant Messaging where mobile services are available, Internet web, wireless access protocol (WAP), and the like. Such mobile devices can include any type of wireless mobile device including cellular telephones, personal digital assistants (PDA), pagers, satellite telephones, radio telephones, or any other wireless device allowing text messaging.

The present invention is based on a business model that has four elements: a consumer technology that has become virtually ubiquitous (i.e. a mobile device), a strong corporate interest in reaching a client base that is difficult to reach via traditional advertising media (i.e. young consumers), a system for seamlessly integrating the technology and for hosting the consumer promotion, and a business model that shifts the costs of the promotion to the corporate client while allowing personalized interaction between the consumer and the third party promotional host.

Generally, the present invention is a mobile device based consumer promotional system and method for utilizing the common and popular text messaging services for branding and other consumer promotions. The system provides an interactive consumer promotion via wireless text messaging services while shifting the cost onto a corporate sponsor for the promotion. In particular, the system does not push advertising onto the consumer. Instead, the system utilizes proper messaging etiquette with respect to intrusiveness and to emoticons, so as to interact with the consumers where they interact and play. Specifically, the system offers incentives for consumers to visit and to return again to the system, and to return to the retail outlet for additional codes.

The branding technique, therefore, is largely consumer driven, meaning that the consumer determines whether and when he or she will interact with the promotional system. Consumer preferences and selections can be tracked and used to provide customized content for specific consumers.

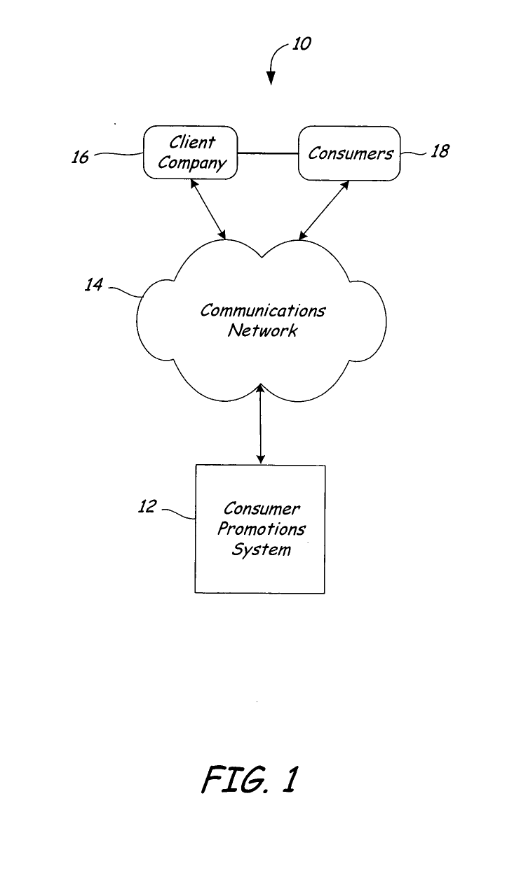

As shown in FIG. 1, the promotional system 10 has a consumer promotions system 12, which is connected to a communications network 14. The client company 16 and consumers 18 interact with each other directly, and interact with the promotions system 12 via the communications network.

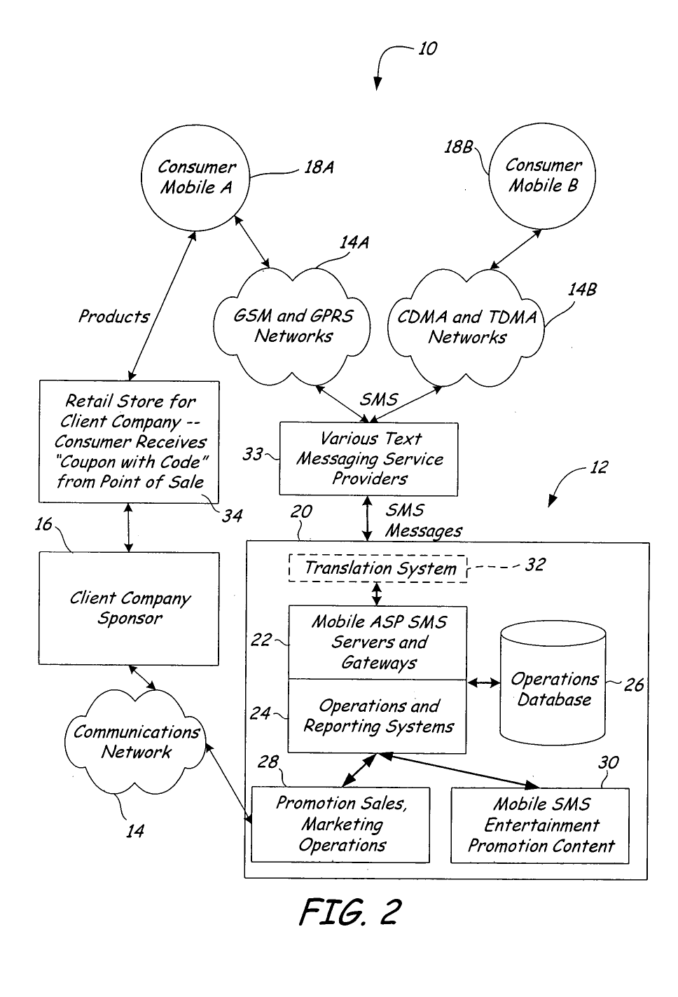

Generally, the communications network 14 may be any network capable of facilitating text-based communications. Specifically, the network 14 may be the Internet, a telephone company network, a satellite network, or any proprietary wireless network. In order to use a mobile device and to have access to a wireless communications network, a consumer must sign up with a wireless service provider 33 (shown in FIG. 2), such as AT&T wireless, Verizon, VoiceStream, Cingular, and other similar two-way short message service centers. Since many service providers 33 for mobile devices have their own proprietary networks, communications across networks may sometimes be complicated. In particular, text communications do not always travel across the proprietary networks in an open standard format. Thus, communicating between proprietary networks does not always work properly at the present time.

Since there is no current universal standard for text messaging via mobile device devices, different network topologies must be anticipated and accounted for, in order to provide a seamless interface for the consumer. Specifically, each wireless carrier can have several differences in wireless protocols, forms and frequencies. At the present time, receiving and sending SMS text messages from and to customers of many different wireless carriers requires “aggregation”. In other words, multiple SMS gateways (or a single gateway emulating multiple SMS gateways) are required where a “client company” wants to have wireless SMS text-based marketing promotions available to all of their customers, regardless of their wireless carriers. However, over time, the various wireless carriers may evolve toward an SMS text messaging standard, such that multiple SMS gateways are no longer necessary.

In FIG. 2, the various networks are broken out to illustrate that they may be proprietary or separate from a communications perspective. In other words, the consumers may access the system 10 of the present invention, regardless of which wireless network they use. In particular, the system 10 has a promotional system 12 which is connected to communications networks 14, 14A, and 14B. Consumers 18A, 18B interact with the client company 16 and with the promotional system 10 via the networks 14A, 14B.

As shown, the promotional system 12 has mobile Application System Provider (ASP) Short Message System (SMS) Servers and Gateways 22, an Operations and Reporting System 24, an Operations database 26, Promotion Sales, Marketing operations 28 and Mobile SMS Entertainment Promotion Content 30. The Promotion Sales, Marketing Operations 28 communicate via a communications network 14 with the client sponsor 16, which is in communication with its retail outlets 34.

The system 12 resides behind a firewall 20, to prevent unauthorized access to the systems. The system 12 includes one or more ASP SMS Servers and Gateways 22 for communicating with the outside world. The mobile ASP SMS server and gateways 22 are powered by operations and reporting systems 24. The operations and reporting systems 24 communicate with an operations database 26, with a Promotion Sales, Marketing operation 28 and with Mobile SMS Entertainment Promotion content 30.

The multiple SMS servers and gateways 22 interact with the promotional content 30 to deliver the promotional content 30 via the servers and gateways 22 into SMS messages. The multiple SMS servers and gateways 22 allows for text messaging across various wireless carriers. Optionally, a single SMS server and gateway 22 can transmit the SMS messages through a translation system 32 for translating the content to the appropriate protocols, forms and frequencies for the selected wireless carrier 33, according to the consumer's mobile phone service. The SMS messages are relayed to the customer's wireless carrier 33 and over their respective networks 14A,14B to the associated consumer mobile 18A,18B for viewing by the consumer. Finally, the Promotion sales and marketing operations 28 link client company sponsors 16 to the operations and reporting systems 24.

Generally, SMS messages are transmitted through the firewall 20 by the mobile ASP SMS server and gateways 22 in the appropriate text messaging format for the specific wireless carrier 33, such as AT&T, Cingular Wireless, Sprint PCS, Verizon, Voicestream and the like. In order to facilitate communications at this time, the multiple SMS servers and gateways 22 translate the SMS text into the appropriate form and format to communicate with the customer, regardless of the wireless carrier 33. If necessary, the system 10 can provide a custom text translation protocol for each available service. Anything less would not provide the type of consumer promotion desired by most companies.

Unlike traditional marketing methods, behavioral data is collected on participating consumers 18 automatically. Since the consumer 18 uses a mobile device to access the system of the promotional marketing system 12 based on an inducement by the client company 16, information about the identity of consumer 18 is immediately collected together with the client inducement codes and various other information. The system 10 captures and stores data from every message in all steps in the messaging process, which can be used to provide an “audit” trail that verifies receipt and delivery of each message to and from the customer, including delivery of messages that provide monetary value. The SMS text messaging system does not necessarily provide a confirmation of the actual receipt of a message by the customer. SMS messages are generally sent to a “store and forward” SMS center, which recognizes when a cell phone is in range and powered on, and then “forwards” the message to the designated receiving phone. Consumer behavior within the system can be tracked and also utilized later for further marketing opportunities.

Generally, the mobile ASP SMS server and gateways 22 communicate SMS messages via any type of two-way text messaging network. The messages are then transmitted, for example, via GSM and GPRS networks 14A or via CDMA & TDMA networks to mobile wireless consumers.

In one embodiment, after the corporate client 16 has established a promotional program with the operators of the system 10, the operators provide the corporate client 16 with pre-printed game pieces according to the specific promotion. The corporate client 16 then decides how to distribute the game pieces to consumers. For example, the corporate client 16 might pass out a small game card or game piece to consumers 18 at their retail outlet 34. For instance, a restaurant might hand out a game card with the purchase of a meal. When the consumer 18 scratches off the game card, the card provides a game code and a telephone number to call.

For consumers 18 who call the telephone number and enter the code, the consumer's telephone number and the code information are stored, thereby identifying the consumer 18 and the store 34 with which the consumer 18 is associated. The consumer 18 can then participate in interactive games and/or contests or download sounds, pictures, or other entertaining items for later use on the consumer's mobile device.

As shown in FIG. 2, consumer 18A interacted directly with the retail outlet 34 and received a game piece, which he or she used to access the promotional system 12. Consumer 18B did not interact directly with the retail outlet, but rather, received the game piece another way, such as via sidewalk distribution, etc. Consumers 18A,18B have different types of wireless systems on different networks 14, but both are able to dial into the promotional system 12 using text messaging because of the multiple SMS gateway concept.

Since the consumer information is stored, the system 10 can be used to generate push-type advertisements or enticements to generate retail traffic. Specifically, the store can then offer this consumer incentives to return to the store and make additional purchases. For a fast food restaurant for example, the store promotion may present a coupon for a free small french fry.

In the context of the present invention, a coupon may be a printed coupon, a digital coupon, a game piece, a ticket or any other device for providing something related to the promotion to a consumer.

For a retail outlet, the consumer may be offered a 10% off coupon on any given item from the store. In this manner, the client corporation 16 can directly reach consumers 18 who have previously visited the store, thereby increasing the opportunities for return visits.

If, for example, the promotion content 30 is a coupon, the coupon is downloaded to the screen of the mobile consumer. The consumer can then show the coupon to the cashier at the retail store to redeem the coupon. If the consumer is not currently at the store location, the consumer can dial up the coupon at a later time and retrieve it from the database according to his consumer 18 identification. The coupon can expire after a period of time, or alternatively the retail store can visit a website location or download a code number in order to deactivate the code once it is used.

If the retail stores 34 distribute the card, the retail stores 34 control distribution of the coupon codes. When the consumer 18A uses the GSM or GPRS network 14A over one of the wireless provider networks to access the system 10, the mobile ASP stores the consumer 18 information in a database and utilizes the operations and reporting systems to retrieve the mobile SMS entertainment promotion content 30 associated with the code from the coupon. This content may include such things as coupons for future products, a coupon code for free product, a display image to be stored as background on the wireless device, or a sound, a game or any other content as deliverable via a wireless text messaging service.

More importantly, by providing text based downloads and interactive activities for the consumers 18A,18B, the corporate client 16 can coopt some of the positive feelings toward the messaging service in general. Specifically, by reaching the consumer 18 where he or she “plays”, the corporate client 16 interacts in a positive way, directly with the consumer 18. This interactive opportunity can generate a positive branding experience for a corporate promotion.

Various companies have tried to use the Internet or other means for providing similar promotional activities. For example, bottling companies have often placed printed codes on the inside of the bottle cap and encouraged consumers to call a telephone number or visit a web site and enter the code to determine if a prize is won. However, these previous promotional efforts required the consumer to perform the action later, and did not provide the consumer with opportunities to make choices and to interact with the system.

In this instance, the telephone number and code gives the consumer 18 an opportunity to access the host promotional system 12 immediately (or at any time after) to access interactive games to interact with other online game players, or available downloads, such as musical tunes, images, etc. Such musical tunes or images may be brand related, such as a jingle or a corporate logo. For example, a consumer 18 might dial in the code and visit the site 12 to download a new ring (such as the “I'm a Pepper” song for Dr. Pepper soda) for their telephone.

The multiple servers and gateways 22 provide a platform for text-based communications across wireless networks. More importantly to corporate clients, the system 10 allows many forms of text messaging dialog to be conducted with individual customers, or to facilitate competition between customers. The forms of messaging dialog can be text, audio (such as ringing tones), or pictures (images for display on the cell phone or to forward to others). As the telephone technology advances, more and more consumers will be able to view moving images on their phones as well.

The promotion sales, marketing operations 28 include specific software (not shown) for designing and building SMS marketing promotions. Moreover, the software automates the promotions business process to provide a reliable, auditable and verifiable marketing program. Additionally, the promotion sales, marketing operations 28 can be used to analyze the stored data, and reports. the data to the client corporation 16 over a communications network 14 (which may be a telephone network, the Internet, etc.). In this report, data can be quite extensive as the collected data will be collected over time and via many distinct messages.

Properly used, the brand marketing promotions of the present invention utilize the functionality of mobile telephone devices and the proven positive characteristics of mobile messages to create interactive communications which can positively impact a relationship between individual consumers and the brand. Specifically, free stuff offered via the interactive promotional system encourages a positive feeling about the brand with which the free stuff is associated.

As previously indicated, generally network operators utilize different messaging formats and protocols, which do not translate across networks 14. Corporate clients 16 do not want to provide such telephone services to only one type of telephone or one type of cellular or wireless network. Such a promotion would serve to alienate large groups of consumers. The present system 10 uses multiple SMS servers and gateways 22 to seamlessly integrate the messaging technologies across multiple platforms, allowing for text communications regardless of the telephone used. This technology allows corporate clients 16 to offer the telephone based promotional opportunities without concern for alienating particular consumers.

Additionally, the client company 16 can use the consumer promotion system 12 to offer promotions based on consumer location. Specifically, this location awareness allows the interactive promotional system to identify the location of the consumer 18 relative to particular promotional clients in order to offer the client promotion incentives to customers when in general proximity of the retail client. The direct consumer interactive promotional opportunities available through the system 10 allow for multiple consumer 18 participants, each participating independently of one another and/or in competition with one another. Specifically, depending on the promotion, individual consumers 18 can by continuing to participate receive offers and other items that may or may not be available to other participants in the group, based on customization of offerings based on consumer 18 behavior and so on.

As previously mentioned, mobile messages have proven characteristics with youth consumers that act at psychological and behavioral levels. These characteristics include social acceptance, personalization, identification, social and group communication, fun, entertainment, simple and fun to use, text messaging language. From the youth consuming public's perspective, the parents simply “don't get it”.

Thus, the present system provides interactive consumer promotional services geared toward youth and teenage customers in order to directly reach these consumers where they already “hang out” and play. Unlike other consumer promotion opportunities, the present invention doesn't try to change where they go or what they do, but rather attempts to reach them on their own playing field on their own terms.

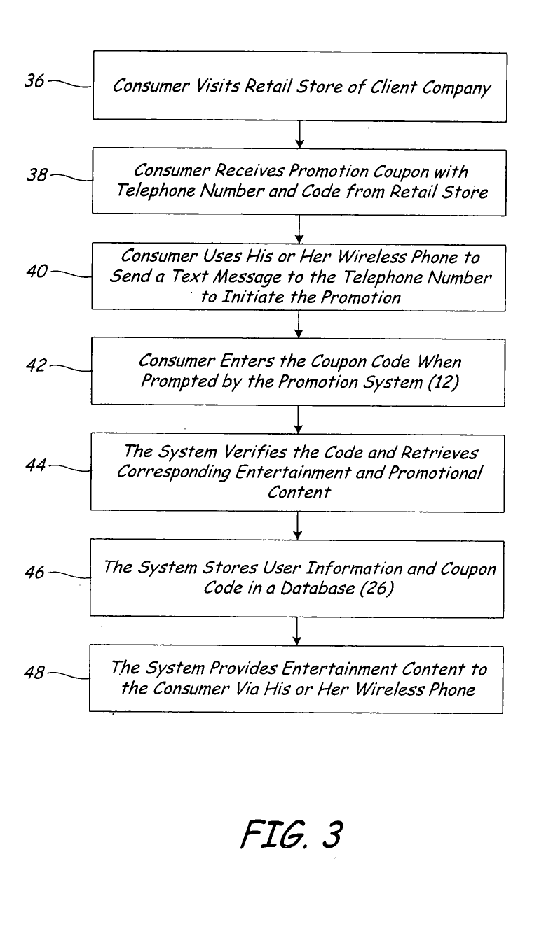

A flow diagram of a typical promotion is illustrated in FIG. 3. As shown, a consumer 18 visits a retail store 34 of a client company 16 (36). The cashier or other employee of the retail store 34 distributes a game piece to the consumer 18. The consumer 18 receives the promotional coupon (or game piece) and scratches off or otherwise plays the game piece to reveal a telephone number and a code (38).

The consumer 18 then uses his or her mobile device or PDA to send a text message to the telephone number to initiate the promotion (40). The system 10 receives the call and prompts the consumer 18 for a code. The consumer 18 enters the coupon code (42). The Promotional System 10 then verifies the code and retrieves the corresponding Entertainment and Promotional content (44). The System 12 stores information about the consumer 18 (such as his or her telephone number, the coupon code, the consumer's physical location, and the like) in a database (46). Finally, the System 12 provides entertainment content to the consumer 18 via his or her mobile device (48).

Current telephone services that provide such interactive downloading typically charge the telephone users a fee for the service. Specifically, to dial into a service to download a brand new ring for the telephone, the consumer is charged $ 1.00 (one dollar) for the call. And typically, the cost for the particular downloaded ringing tone or picture is charged to the telephone bill. With the present invention, however, the consumer promotion is sponsored by a corporate client 16 such that the corporate client 16 pays for the promotional elements. The consumer 18 is charged only according to their own phone usage according to their contract with their service provider. Thus, the consumer 18 is not charged for the promotional elements.

The system 10 is set up so that client companies 16 with consumers 18 to whom they are doing market promotions pay at least a significant cost of the promotion on their end. Consumers 18 generally pay for their own mobile device and the wireless service costs associated with their part of the promotion. In other words, the consumers 18 typically already pay for these services, and therefore the consumer promotion doesn't add additional expense to the consumer's end.

The client companies 16 associated with or who may want to be associated with this type of promotion are numerous. From fast food restaurants to grocery stores and from entertainment companies to chat services, this type of consumer interactive promotional activity generates traffic, because it encourages people who already are using these types of chat services to traffic the system 10. This type of direct marketing in the past has been extremely difficult to do, and direct consumer marketing typically has been limited to a single corporation or a single store front such as with frequent buyer card activities. However, such promotions require the consumer 18 to continue to carry the card on their person. By contrast the present promotional activity utilizes an item that most people carry with them already, namely a telephone.

As previously discussed, the present invention relies on existing telephone network infrastructures that allow for instant text messaging. Typically, such instant text messages are available on most current or up-to-date technological mobile devices. The text messaging services are available on networks including GSM, CDMA, TDMA, 2.5G, 3G, WCDMA, and the like. Other wireless networks may also be used including pager networks, personal digital assistants, infrared, WiFi (802.11x). Additionally, wireless access protocols (WAP) and other Internet based access is available not only to the mobile devices but also to work stations so that consumers 18 could access via their telephone or via a computer connection.

Direct queries and other types of polling questions may be asked of consumers 18 who participate in the program directly, in order to gain more information about the consumer 18 or about a product release. Maintenance of such data and the data contained in specific text messages is stored in the system and may be made available to corporate clients 16 as required.

The types of services or promotional activities that are interactive that would appeal to young people include such things as games, free stuff directly related to the corporate brand, and the like. For example, a company could sponsor a trivia game where the winner wins a cash award or free stuff. Another company might offer free hats or some kind of free sandwich or the like for participants in a promotional activity.

As the technology for mobile devices has evolved, the LCD display for many mobile devices has become increasingly versatile. In particular, many LCD displays are capable of displaying video images having a fairly high resolution. This allows the promotional activity to actually display videos, commercials, and/or offer an online channel for example.

One possible way to induce further consumer traffic and to attract a great deal of youth interest and enthusiasm is for a corporate client 16 to sponsor a two hour segment of a music video channel for example. During that segment, consumers 18 who have registered with the promotion can post text messages to a moderated forum. The “moderated” messages can then be posted to the television screen. It is expected that if one young person posts a message that at least he and a couple of his friends will view the message on the channel. This drives interactive consumer participation and captures an audience that may not otherwise be in front of the TV or on a particular channel. Thus, a corporate sponsor 16 can be assured that during a particular time segment sponsored by that particular sponsor 16, these customers are going to be looking at that channel to see what messages he or his friends have already posted.

It is expected that the corporate sponsor 16 would want to moderate the text messages to ensure a level of decorum. Alternatively, software can be developed to handle a good portion of the moderating.

Finally, because the system 10 is integrated, the promotional system 12, and particularly the sales/marketing operations 28 can be used to generate an audit trail for used coupons. Typically, promotions people or companies need to verify and audit trail whatever coupons are distributed. This is difficult to do with current coupons and the audit trail is totally a paper trail. In the present invention, coupon audit trails are no longer paper alone. Specifically an audit trail can be created that is a mixture of paper and cell phone information so that the redemption of the coupon doesn't slow down the checkout process. This is very important particularly in the fast food market where checkout speed is of the essence. The system already collects data on the entire transaction where the cell phone is involved, which is far more than what happens with traditional paper coupons. In terms of overall data, the system 10 collects behavioral data by individual, which has tremendous marketing value. Additionally, the system 10 collects data on the entire transaction process from distribution of the coupon to redemption and further processing, which provides audit capability and control. Moreover, the digital audit trace of the actual consumer's interaction with the promotional system 12 provides an instantly available marketing database for future use by the client company 16. Moreover, the client company 16 can distribute coupons to consumers of mobile products regardless of what type of mobile product they use. In general, all known text messaging wireless protocols are available to the consumer seamlessly so that the consumer does not need to be aware that he is traversing multiple networks to access the system. As new messaging protocols are created, the filters and/or translators will be developed as needed.

Generally, as previously discussed, the process begins with the issuance of a printed coupon to a consumer 18, who then “opts-in” to the marketing promotion using his or her mobile device. The coupon may be a manufacturer coupon (redeemed at retail for which the retailer must obtain reimbursement from the manufacturer), a retailer coupon (redeemed at the issuing retail location), and prizes in electronic and/or mobile form (issued electronically).

Each printed coupon has a machine readable code in a form consistent with the redemption of manufacturer coupons, such as a bar code or optical character recognition code. The purpose of the code on the coupon is to identify the specific promotion and coupon value, which is typically entered into the retail point of sale (POS) terminal for use in the retail check out process.

Each coupon may also have a second code as a unique identifier. In one form of the process, the unique code is pre-printed on the coupon, and this unique code can be submitted to the marketing promotion system 12 by the consumer 18 via a mobile device. Optionally, a unique identifier code such as the mobile phone number, personal identifier number, or other could be written on the coupon containing the promotion code at the time of coupon redemption.

The marketing promotion system 12 stores all data transmitted during the promotion dialog between the consumer 18 and the system 12. This data and the associated process ensures the integrity, verifiability and auditability of the marketing promotion process and the delivery of value to the consumer 18 from the system 12 (or from the client sponsor 16) for the situations of retailer coupons and prizes as identified above.

The machine readable promotion code in conjunction with the code the consumer 18 uses to access the system 12 allows any manufacturer coupons to be redeemed and processed by the retailer in the same manner as the majority of the manufacturer coupons. The addition of the second unique code on the coupon, whether pre-printed in machine readable form or entered manually in handwritten form, when combined with the data stored by the promotion system 12 allows verifiability, integrity and auditability of the marketing promotion. The system 12 can be used to track the coupons as a form of value through the entire process from initiation of the promotion through the redemption of the coupon. Coupons and other forms of value may be tracked via the promotions system.

A further means of communicating the unique code to identify the consumer 18 who receives a coupon of value in the manufacturer coupon form is for the consumer 18 to communicating their unique code electronically from their mobile device to the point of sale retail terminal at the time of the coupon redemption. In other words, the consumer 18 could simply show the electronic coupon to the cashier. This could replace the need for a preprinted code or manually writing a code on the coupon at the time of redemption. Of course, this would require that the retail point of sale terminals have the means to communicate with the mobile devices, either directly using means such as “Bluetooth”, “WiFi 802.11x”, infrared or other wireless communication or via the consumer sending a text message with the unique identifier code either to the host system to transmit to the retailer or directly to the internal system of the retailer which then combines that information with the information about that specific check out transaction.

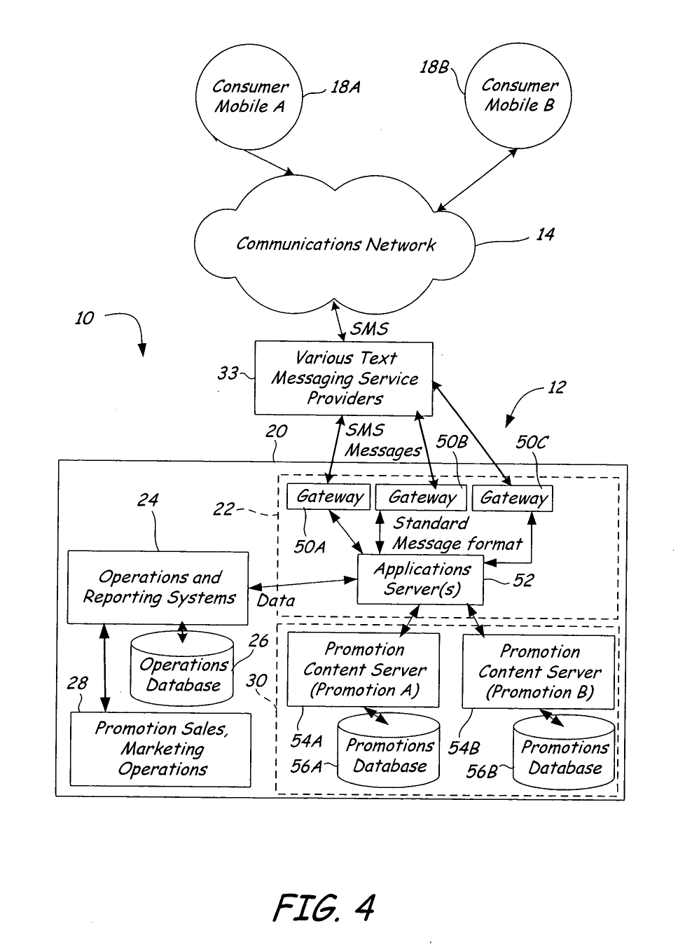

As shown in FIG. 4, the consumer promotions system 12 has mobile ASP SMS servers and gateways 22 (shown in phantom), Operations and Reporting Systems 24, an Operations Database 26, Promotion Sales, marketing operations 28, and Mobile SMS Entertainment Promotion Content 30 (shown in phantom).

The servers and gateways 22 includes multiple SMS gateways 50A,50B,50C for translating SMS messages to and from the various text messaging service providers 33 and into a standard message format. The messages are then passed in a standard message format to the applications server 52, which hosts the session for the consumer 18. Specifically, the applications server 52 retrieves the promotional content from the promotion content server 54, which in turn retrieves promotion specific content from the promotions database 56.

Additionally, the applications server 52 passes data from the standard formatted messages to the operations and reporting system 24 for storage in the database 26. All interactions between the customer 18 and the promotional program are hosted by the applications server 52, allowing for simple auditing of all customer 18 interactions.

In one embodiment, each wireless promotion hosted by the promotions system 12 has its own promotion content server 54A, 54B and its own promotions database 56A, 56B. The promotion content server 54A, 54B assembles the promotional content retrieved from the promotions database 56A, 56B. The Application server 52 routes data to and from the appropriate promotions server 54A, 54B.

During operation, the application server or servers 52 maybe hosting multiple sessions between customers 18 and the promotional content servers 54A, 54B at any given time. Thus, the Application server(s) 52 controls and coordinates interactions between the customer 18 and the specific promotions server 54A, 54B. When customers 18 are playing games or interacting with the system 12, such coordination is imperative so as to correctly route packets to the appropriate recipient.

### EXAMPLE OF THE OPERATION

Although operation of the present invention is apparent from the preceding description, an example is presented below to provide a more complete understanding of the present invention.

An SMS text message originates with a youth customer 18. The youth customer 18 keys a message into his or her wireless phone, and then “sends” the message to a cell phone number (or a special “short code” number application server supplied by the wireless carrier 33). The text message is carried by the customer's wireless carrier 33 over the wireless carrier's cellular network 14 to the carrier's SMS Center (not shown). Generally, the text message is carried using the carrier's specific form (GSM, CDMA, TDMA, GPRS, etc.), frequency (900, 1800, 1900 MHz are primary ones), and SMS protocol (there are several, for example in Finland the 4 main carriers each have a separate but similar SMS protocol).

The carrier's SMS Center is essentially a computer server that receives messages, then identifies and locates the target cell phone, and forwards the message once it recognizes the target and determines the target is in range.

The carrier's SMS Center forwards the message to the “message aggregator” (the SMS Text Messaging Servers and Gateways 22), usually but not necessarily via the Internet or a dedicated telecomm connection. The present invention utilizes the Internet SMPP protocol, allowing customers to be in range all the time. In a preferred embodiment, the “aggregator” is a gateway complex of the type produced and maintained by Arena Partners of Finland. However, the aggregator could be an “aggregator supplier”. The gateways can be a mix of software and hardware.

The appropriate gateway 50A,50B,50C then converts the SMS message content to a standard message format or common protocol and forwards the message to the application server 52. The application server 52 processes the incoming message and routes it to a specific application on a specific promotion content server 54A for a specific client company 16 using data included in the SMS message, as well as information with the message such as sending and receiving phone numbers, time of message, etc. In other words, such text messages include header and content information that allows the application server 52 to identify and retrieve the appropriate content for responding.

The application server 52 hosts application software that processes the message, determines the appropriate response message to continue the dialog with that customer 18, and then “sends” that response message to the customer's phone number based on the retrieved promotions content retrieved from the promotion database 56A and assembled by the promotion content server 54A.

The response message is then passed to the appropriate gateway 50A,50B,50C and converted to the appropriate SMS format for the customer's wireless provider 33, before it is passed to the customer's wireless provider. The customer's wireless provider 33 then forwards the SMS message to the customer 18 via the communications network 14.

The promotions operation examines each transaction to look for and solve problems of a wide variety, to provide necessary information to the clients and other business partners using the transaction database and software, and also to provide marketing data such as Customer Relationship Management (CRM) data via software analysis and reporting. Such examination may occur manually as each new promotion is being implemented or as new corporate clients 16 are added to the system 12. However, such examination is largely automated on a day-to-day basis.

While the present invention has been described with respect to downloads and interactive consumer participation in games, contests and the like, it is anticipated that the wireless promotion may also involve television. Specifically, instead of offering contests or games, the promotion may involve Chat Television. Chat television, as it is used herein, refers to television programs that allow viewers to submit text messages for posting on the television screen. Such messages may be displayed in a static box or a scroller bar or anywhere on the screen while the television program is in progress.

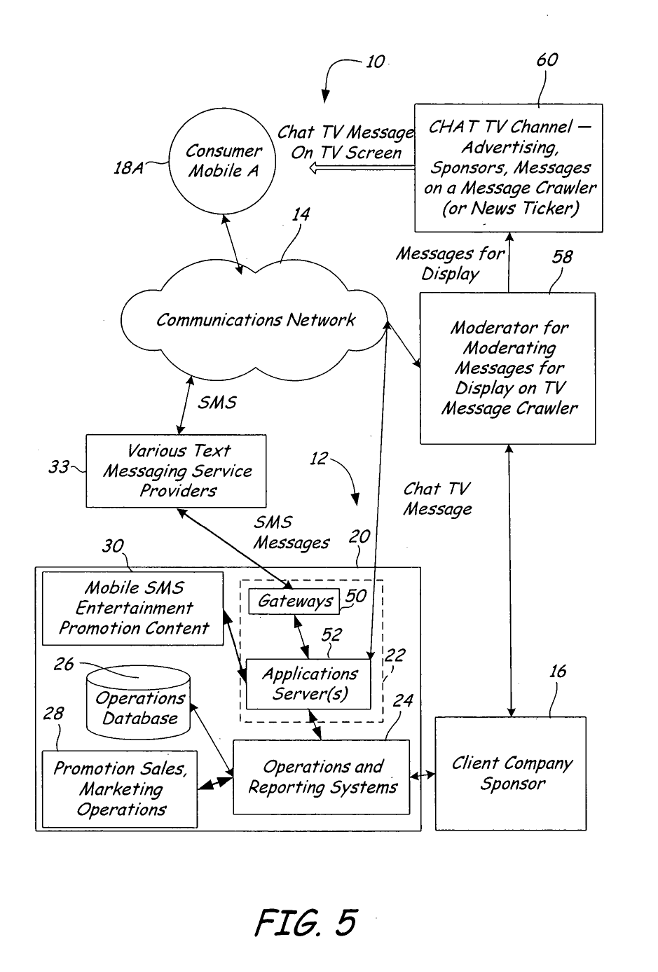

As shown in FIG. 5, text messages are transmitted by the consumer 18 over the communications network to the promotions system 12. The SMS message is received from the service provider 33 and translated by the gateways 50 into a standard text format. The message is then parsed by the application(s) server 52. If the message is associated with a Chat TV promotion, the application server(s) transmits the message body to a moderator 58 for the Chat TV promotion via the communications network 14 (most likely via the Internet).

The moderator 58 reviews the message content to make sure that the content is acceptable, and posts the message to the message crawler on the Chat TV channel 60. Consumers 18 can watch the Chat TV channel during a pre-scheduled time-slot to see their messages appear. Such a time-slot is determined by the corporate sponsor.

In this example, the corporate client 16 distributes game pieces or coupons to their consumers 18. Each coupon allows the consumer 18 to post one or more messages to the Chat TV channel. The corporate client 16 sponsors the text messages for its consumers. In this example, the corporate client 16 may, for example, sponsor a show on a television channel. During the show, text messages sent by consumers 18 and reviewed by the moderator 58 scroll across the bottom of the screen.

In this instance, a consumer 18 with a coupon is able to enter the coupon code and send as many messages as the coupon allows. Once that number of messages is exceeded, the consumer 18 may either pay to post more messages or the consumer 18 can no longer post to that Chat TV session unless he or she gets another coupon from the retailer sponsor. If the consumer 18 wishes to continue posting, messages, provision could be made at the discretion of the retailer to charge such messages directly to the consumer.

In addition to posting text messages on the Chat TV screen in static or crawl form, one or more graphic ads are displayed on the Chat TV screen. This provides advertising value for the retailer sponsor and Chat TV channel, particularly given that the audience is heavily determined by the sponsored promotion(s) and would have very high demographic and other characteristics appropriate to the promotion(s). Advertising rates for the graphic and traditional ads could be very competitive with traditional programming and audiences.

In general, the present invention is a business method for acting as a third-party host for branding and marketing promotions. The system 10 hosts promotional content, routes text messages, and directs consumers to the appropriate promotional content according to the code entered by the consumer 18. Additionally, the system tracks and stores data relating to the consumer's interactions with the promotions, providing detailed audit reports for corporate client's to evaluate current and past promotions and to direct focused marketing efforts at participating consumers.

Although the present invention has been described with reference to preferred embodiments, workers skilled in the art will recognize that changes may be made in form and detail without departing from the spirit and scope of the invention.

1. A system for hosting a direct marketing promotion via a wireless network comprising:
an aggregator having one or more gateways for receiving and translating text messages received from SMS networks into a standard message format;
one or more application servers for receiving each translated text message and for retrieving promotional content from a database according to information contained in the translated text message.

2. The system of claim 1 further comprising:
an operations system for managing and monitoring the one or more application servers, the operations system having a memory for storing information about each interaction with the one or more application servers.

3. The system of claim 1 wherein the retrieved promotional content is a download file selected from a group consisting of a game, a sound, and an image.

4. A method for providing direct marketing promotional content to a consumer who opts in via a wireless network, the method comprising:
providing a game piece to a consumer, the game piece including a telephone number and a code;
receiving a text message from a consumer including the code;
authenticating the code with an application server against a promotions database;
retrieving promotional content from the promotions database according to the code;
transmitting the retrieved promotional content to the consumer; and
logging all interactions between the consumer and the promotion system.

5. The method of claim 4 further comprising:
generating an audit report for a corporate sponsor based on the logged interactions.

6. The method of claim 4 wherein the step of receiving comprises:
receiving the message with a gateway specific to a service provider of the consumer; and
translating the received message into a standard format.

7. The method of claim 4 wherein the step of transmitting comprises:
passing the retrieved promotional content to a gateway specific to a service provider of the consumer; and
translating the retrieved promotional content to SMS text message format specific to the service provider of the consumer.

8. A method for hosting a wireless promotion comprising:
assigning a code to promotional content stored in a promotions database;
retrieving the promotional content on request from a consumer with the code; and
transmitting the promotional content to the consumer.

9. The method of claim 8 wherein the promotional content is one or more menus, the method further comprising:
offering a menu selection to the consumer for choosing between downloadable items.

10. The method of claim 8 wherein the consumer is a wireless customer with wireless access to text messaging services via a wireless service provider.

11. A method of hosting an interactive telephone based promotion comprising:
contracting with a client business to host an interactive promotion;
storing promotional content for the interactive promotion;
delivering game pieces to the client business, the game pieces including a telephone number and a promotional code corresponding to the interactive promotion; and
transmitting wirelessly the stored promotional content to a consumer's telephone upon request by a consumer in possession of a game piece distributed by the client business.

12. The system of claim 11 wherein the consumer is not charged for accessing the interactive promotion.

13. The system of claim 11 wherein the promotional content includes menu options, downloadable items, and interactive games.

14. A system for hosting interactive text sessions from wireless telephones hosted by different wireless providers, the system comprising:
an aggregator for translating between text messaging protocols, the aggregator comprising:
protocol information for each service provider, the protocol information including format and frequency protocols specific to each service provider; and
one or more gateways for converting messages from each of the service providers to a standard format messages and for converting standard format messages to provider specific messages according to the protocol information.

15. The system of claim 14 further comprising:
an application server for hosting interactive sessions between the system and a consumer.

16. The system of claim 14 further comprising:
an application server for retrieving and delivering promotional content to a consumer via the aggregator.

17. A method for generating a promotions audit trail for a client business, the method comprising:
hosting an interactive promotion wherein a consumer dials a number on a wireless phone, enters a code as a text message, and transmits the code to a promotions system;
receiving the code as a text message;
parsing the text message to retrieve information about the consumer; and
storing the information in a database.

18. The method of claim 17 further comprising:
logging all interactions between the consumer and the promotion system in the database.

19. The method of claim 18 wherein the interactions are stored in relation to the consumer and the code, each code being linked to a specific promotion.

20. A method for providing an interactive promotion to wireless consumers, the method comprising:
distributing game pieces containing a number and a code to entice wireless consumers to call the number and enter the code;
hosting the interactive promotion by receiving calls from consumers and by retrieving stored promotional content from a database according to the entered code; and
transmitting the retrieved stored promotional content to the consumer.

21. The method of claim 21 wherein the retrieved stored promotional content is a menu providing selection options for a consumer to download items.

22. The method of claim 20 wherein a client corporation pays for the interactive promotion and wherein the consumers are not charged for accessing the promotion.

23. A method of hosting an interactive promotion for a client, the method comprising:
coordinating sponsorship by a client of consumer text messages on a chat television program on a television station;
routing consumer text messages intended for the chat television program to a moderator;
displaying moderator approved text messages on the chat television program.

24. The method of claim 23 further comprising:
distributing game pieces at a retail outlet of the client allowing for a certain number of text messages on the chat television program.

25. The method of claim 23 wherein the client sponsors the chat television program and pays for the consumer text messages.

26. A third party host of a wireless promotion for a corporate client on chat television program on a television station comprising:
an aggregator for receiving and translating text messages from consumers in proprietary formats into a standard format;
an applications server for determining a promotional program according to a promotional code contained in the received text messages; and
a display application for posting messages from the consumers on the chat television program.
